(19) United States
(12) Patent Application Publication
(10) Pub. No.: US 2015/0070325 A1
(43) Pub. Date: Mar. 12, 2015

(54) IMAGE CONTROL APPARATUS, IMAGE PROCESSING SYSTEM, AND COMPUTER PROGRAM PRODUCT

(71) Applicant: Takanori Nagahara, Kanagawa (JP)

(72) Inventor: Takanori Nagahara, Kanagawa (JP)

(21) Appl. No.: 14/387,900

(22) PCT Filed: Apr. 18, 2013
(86) PCT No.: PCT/JP2013/062144

§ 371 Date: Sep. 25, 2014

(30) Foreign Application Priority Data
Apr. 24, 2012 (JP) 2012-098834

(51) Int. Cl. G06F 3/0488; G06F 3/0354; G06F 3/042

(52) U.S. Cl. CPC G06F 3/04883; G06F 3/042; G06F 3/03545; G06F 2203/04808
USPC 345/175

(57) ABSTRACT

An image control apparatus that generates and outputs a drawing image includes an identification unit that uses position information of an object that is close to or in contact with a display device, which is controlled to display the drawing image, and determines whether the object corresponds to a drawing device; and an image generation unit that generates the drawing image using the position information of the object and outputs the generated drawing image. When the drawing device comes into contact with the display device, the image generation unit generates the drawing image using position information of the drawing device.

### TECHNICAL FIELD

The present invention relates generally to an image processing system for generating a drawing image and particularly to an image control apparatus that generates a drawing image based on a user command and prompts a display device to display the generated drawing image.

### BACKGROUND ART

Electronic blackboards implemented in large displays that display a background image for enabling a user to freely draw images such as characters, numbers, and figures are conventionally used in meetings of businesses, educational institutions, and governmental institutions, for example.

Such electronic blackboards include a type that uses a light shielding touch sensor. The light shielding electronic blackboard irradiates light that is parallel to a screen face, detects a position on the screen at which light is shielded as the position where an object such as a finger or a dedicated pen is touching the screen, and obtains the coordinates of the detected position.

However, in the electronic blackboard using the light shielding method, the timing at which light is shielded may vary from the timing at which the object actually touches the screen. Accordingly, techniques are being developed to improve the drawing accuracy of the electronic blackboard by using a dedicated pen to draw an image on the screen and accurately calculating the touch timing of the dedicated pen.

For example, Japanese Laid-Open Patent Publication No. 2003-99199 discloses a coordinate input device that accurately calculates an actual touch timing using light that is emitted by a dedicated pen. In the disclosed coordinate input device, when it is detected that light has been shielded by an object, this is determined to be the object coming into contact with a screen. Thereafter, if light (signal) that is emitted from the dedicated pen when it touches the screen is received, the object touching the screen is determined to correspond to the dedicated pen.

However, in the above coordinate input device, after the dedicated pen shields the light emitted from the electronic blackboard, the dedicated pen may not emit the light (signal) in a case where a user holds on to the dedicated pen and does not let it touch the screen or in a case where the dedicated pen is out of power. In such a case, the coordinate input device may erroneously determine that an object other than the dedicated pen has shielded the light emitted by the electronic blackboard. Thus, even when the user uses the dedicated pen to draw an image on the electronic blackboard, the coordinate input device may not be able to recognize that the dedicated pen is being used, and the drawing accuracy of the image may be degraded to that when an object other than the dedicated pen is used.

### DISCLOSURE OF THE INVENTION

It is a general object of at least one embodiment of the present invention to provide an image control apparatus and image processing system that substantially obviate one or more problems caused by the limitations and disadvantages of the related art.

According to one embodiment of the present invention, an image control apparatus that generates and outputs a drawing image includes an identification unit that uses position information of an object that is close to or in contact with a display device, which is controlled to display the drawing image, and determines whether the object corresponds to a drawing device; and an image generation unit that generates the drawing image using the position information of the object and outputs the generated drawing image. When the drawing device comes into contact with the display device, the image generation unit generates the drawing image using position information of the drawing device.

According to an aspect of the present invention, an image control apparatus and an image processing system with improved drawing accuracy may be provided by enabling accurate identification of an object that comes close to or comes into contact with a display device, which is controlled to display a drawing image. By using position information of an object that comes close to or comes into contact with the display device to determine whether the object is a drawing device, the object may be accurately identified and the drawing accuracy may be improved, for example.

### BRIEF DESCRIPTION OF THE DRAWINGS

FIG. 1 illustrates an image processing system according to ah embodiment of the present invention;

FIG. 2 illustrates a hardware configuration of a drawing device according to an embodiment of the present invention;

FIG. 3 illustrates a functional configuration of an image control apparatus included in an image processing apparatus according to an embodiment of the present invention;

FIG. 4 is a flowchart illustrating process steps executed by the image control apparatus; and

FIG. 5 illustrates a manner of identifying an object that comes close to or comes into contact with a display device of the image processing apparatus.

### MODE FOR CARRYING OUT THE INVENTION

In the following, embodiments of the present invention are described with reference to the accompanying drawings.

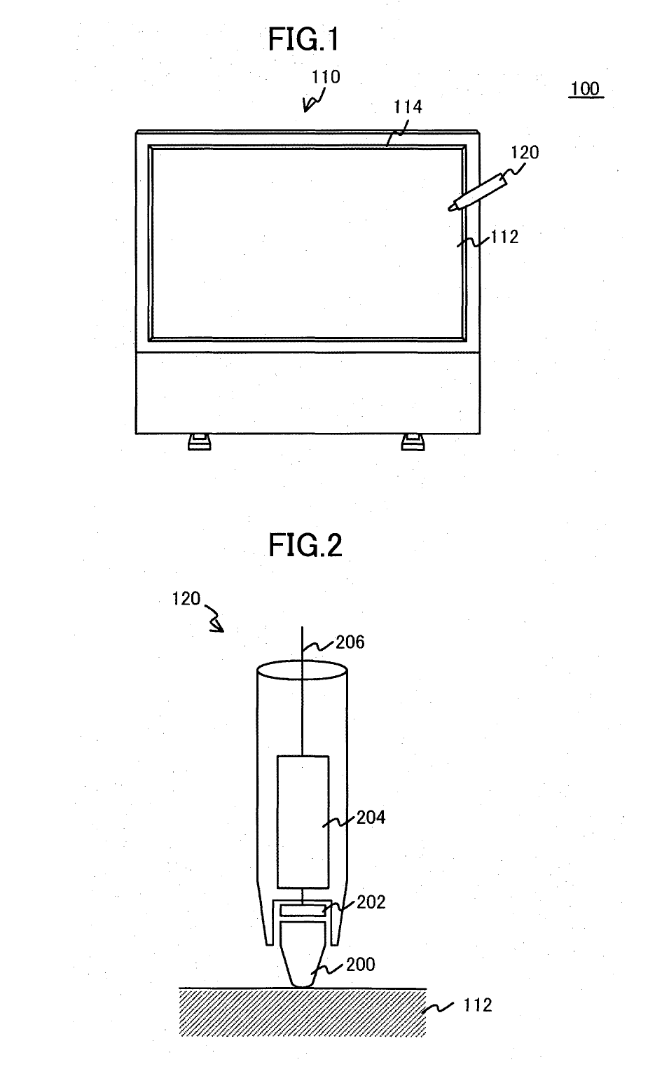

FIG. 1 illustrates an image processing system 100 according to an embodiment of the present invention. The image processing system 100 includes an image processing apparatus 110 and a drawing device 120.

The image processing apparatus 110 is configured to display a drawing image generated by a user. The image processing apparatus 110 includes a display device 112 and a coordinate detection device 114.

The display device 112 is configured to display various images including a drawing image. The coordinate detection device 114 is configured to determine the position of an object such as the drawing device 120 or a finger that comes close to or in contact with the display device 112.

In the present embodiment, a coordinate input/detection device that uses an infrared light shielding method as described in Japanese Patent No. 4627781 is used as the coordinate detection device 114. In this coordinate input/detection device, two light receiving/emitting devices arranged at lower side end portions of the display device 112 are configured to irradiate plural infrared light beams that are parallel to the display device 112 and receive reflected light on the same optical path that is reflected by reflecting members arranged at the periphery of the display device 112.

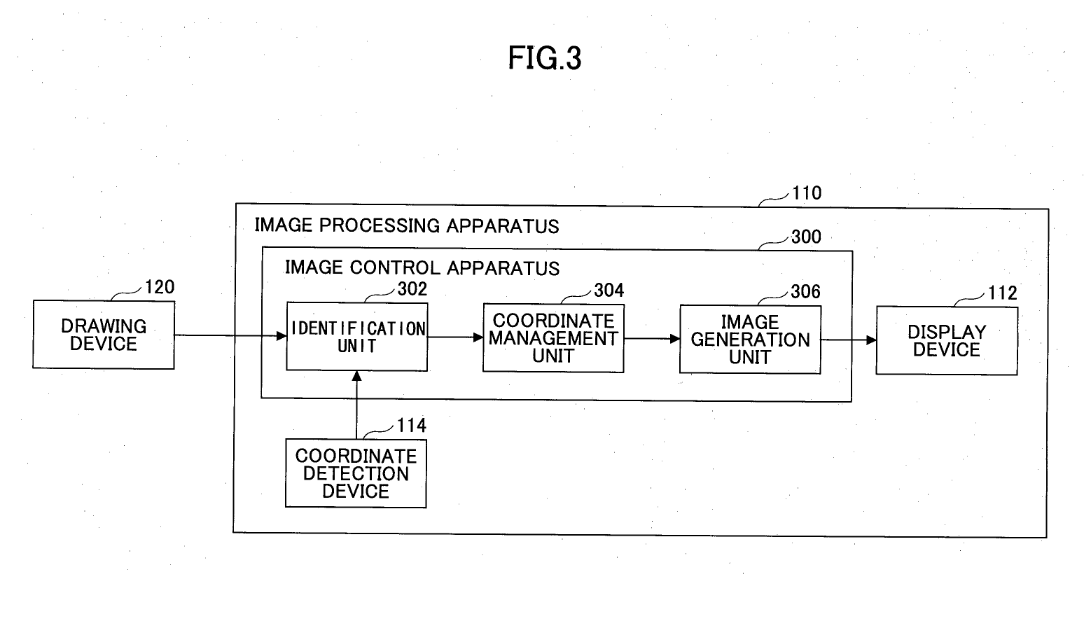

When the light receiving/emitting devices detect a shielding of the light, the coordinate detection device 114 transmits a light shielding signal indicating that the light has been shielded to an image control apparatus 300 (see FIG. 3) of the image processing apparatus 110. Also, the coordinate detection device 114 uses identification information of the irradiated light from the light receiving/emitting devices that has been shielded by an object to determine the position of the object that has come close to or has come into contact with the display device 112, and calculates the coordinates on the screen of the display device 112 corresponding to this position. The coordinate detection device 114 further calculates light shielding region information including theses coordinates, and transmits the light shielding region information to the image control apparatus 300.

The image processing apparatus 110 includes a processor, a ROM, a RAM, and a hard disk drive (HDD). The processor is an arithmetic and logic unit (ALU) such as a CPU or a MPU that is run on an operating system (OS) such as Windows (registered trademark), Unix (registered trademark), Linux (registered trademark), TRON, ITRON, μCITRON, and is configured to execute, under management of the OS, a program that is described in a programming language such as C, C++, Java (registered trademark), JavaScript (registered trademark), Perl, Ruby, or Python. The ROM is a nonvolatile memory that is configured to store boot programs such as BIOS and EFI. The RAM is a main storage device such as a DRAM or a SRAM that provides a working area for executing a program. The HDD stores software programs and data on a permanent basis, and the processor reads a program stored in the HDD and loads the program on the RAM to execute the program.

The drawing device 120 is configured to prompt the image processing apparatus 110 to generate a drawing image. The drawing device 120 may be arranged into a pen-like shape, for example. When the tip of the drawing device 120 comes into contact with an object such as the display device 112, the drawing device 120 transmits a contact detection signal indicating that it has come into contact with an object to the image control apparatus 300 included in the image processing apparatus 110. In the present embodiment, the drawing device 120 transmits the contact detection signal through short-distance wireless communication such as Bluetooth (registered trademark) or Near Field Communication. In other embodiments, the contact detection signal may be transmitted through wireless-communication using an ultrasonic wave or infrared light, for example.

It is noted that although the display device 112, the coordinate detection device 114, and the image control apparatus 300 are integrally arranged in the image processing apparatus 110 of the present embodiment, in other embodiments, the display device 112, the coordinate detection device 114, and the image control apparatus 300 may be independent components. For example, the coordinate detection device 114 may be detachably mounted to the display device 112, and the image control apparatus 300 may be configured to receive various items of information from the coordinate detection device 114 and the drawing device 120 and control display operations of the display device 112 based on the received information.

FIG. 2 illustrates a hardware configuration of the drawing device 120. In the following, hardware components and functional features of the drawing device 120 are described.

The drawing device 120 includes a tip 200, a contact detection sensor 202, a contact determination unit 204, and a signal line 206.

The tip 200 is a movable member that comes into contact with the display device 112. When an outer end portion of the tip 200 comes into contact with an object, the tip 200 moves in the longitudinal direction of the drawing device 120 so that an inner end portion of the tip 200 comes into contact with the contact detection sensor 202. An elastic member such as a spring (not shown) is arranged between the tip 200 and the contact detection sensor 202. Thus, when the tip 200 moves away from the object, the elastic force of the elastic member urges the tip 200 to return to its original position.

The contact detection sensor 202 is configured to detect when the tip 200 comes into contact with an object. For example, a pressure sensor such as FlexiForce (registered trademark) by Nitta Corporation or Inastmer (registered trademark) by Inaba Rubber Co., Ltd. may be used as the contact detection sensor 202. When the tip 200 comes into contact with the contact detection sensor 202, the resistance value of the current of the contact detection sensor 202 may change.

The contact determination unit 204 monitors the resistance value of the current of the contact detection sensor 202 to determine whether the drawing device 120 has come into contact with an object. In the present embodiment, the contact determination unit 204 comprises a semiconductor circuit including a voltage conversion circuit, an A/D conversion circuit, a memory circuit, a determination circuit, and an output circuit.

When the contact determination unit 204 detects a change in the resistance value of the contact detection sensor 202, the voltage conversion circuit of the contact detection unit 204 converts the detected change in the resistance value into a voltage, and the A/D conversion circuit converts the converted voltage of the voltage conversion circuit into a pressure signal corresponding to a digital value.

The determination circuit of the contact determination unit 204 compares the pressure signal with a predetermined threshold value stored in the memory circuit to determine whether the drawing device 120 has come into contact with an object, and outputs the determination result as a contact detection signal to the output circuit. In the present embodiment, a change in the resistance value that occurs when the tip 200 actually comes into contact with an object may be converted into a voltage and a digitally converted value of this voltage may be stored as the predetermined threshold value. When the detected change in the resistance value is greater than or equal to the threshold value, the determination circuit determines that the tip 200 has come into contact with an object. When the detected change in the resistance value is less than the threshold value, the determination circuit determines that the tip 200 is not in contact with an object.

The output circuit of the contact determination unit 204 outputs the contact detection signal corresponding to the determination result obtained by the determination circuit to the image control apparatus 300 of the image processing apparatus 110 via the signal line 206. The contact detection signal includes a value indicating that the drawing device 120 has come into contact with an object (true) and a value indicating that the drawing device 120 is not in contact with an object (false).

In the present embodiment, the output circuit of the contact determination unit 204 is configured to periodically transmit the contact detection signal to the image control apparatus 300. However, in other embodiments, the output circuit may be configured to output the contact detection signal indicating that the drawing device 120 has come into contact with an object only when the determination circuit determines that the tip 200 has come into contact with an object.

FIG. 3 illustrates a functional configuration of the image control apparatus 300 of the image processing apparatus 110. In the following, functional features of the image control apparatus 300 are described.

The image control apparatus 300 is configured to generate a drawing image and prompt the display device 112 to display the generated drawing image. The image control apparatus 300 includes an identification unit 302, a coordinate management unit 304, and an image generation unit 306 as functional features.

The identification unit 302 is configured to identify an object that is close to or in contact with the display device 112 and generate coordinate information. The identification unit 302 identifies the object based on an elapsed time from the time point at which the object shields light of the coordinate detection device 114 and an area of the light shielding region of the object. The identification unit 302 uses the light shielding region information provided by the coordinate detection device 114 to calculate the area of the light shielding region of the object. Also, the identification unit 302 calculates the barycentric coordinates of the light shielding region of the object and supplies the calculated barycentric coordinates to the coordinate management unit 304 as coordinate information.

The coordinate management unit 304 is configured to selectively process the coordinate information received from the identification unit 302 and supply the coordinate information to the image generation unit 306. In a case where coordinate points represented by plural sets of coordinate information received from the identification unit 302 correspond to continuous coordinate points, the coordinate management unit 304 combines the plural sets of coordinate information to generate coordinate information representing a group of continuous coordinates. That is, the coordinate management unit 304 generates coordinate information representing a line and supplies the generated coordinate information to the image generation unit 306. On the other hand, in a case where coordinate points represented by plural sets of coordinate information received from the identification unit 302 are not continuous, the coordinate management unit 304 does not combine these sets of coordinate information and supplies the coordinate information to the image generation unit 306.

The image generation unit 306 is configured to generate a drawing image using the coordinate information from the coordinate management unit 304. The image generation unit 306 generates a drawing image by changing a color of a coordinate represented by coordinate information within an image displayed by the display device 112 into a predetermined color.

The image generation unit 306 sends the generated drawing image to the display device 112 and prompts the display device 112 to display the generated drawing image.

The image control apparatus 300 illustrated in FIG. 3 comprises a semiconductor device such as an ASIC (Application Specific Integrated Circuit) that implements a program according to an embodiment of the present invention for enabling the functions of the identification unit 302, the coordinate management unit 304, and the image generation unit 306. In the present embodiment, the image control apparatus 300 executes the program so that these functions may be implemented on the image control apparatus 300. In another embodiment, the program for enabling the above functions may be loaded in the RAM of the image processing apparatus 110 so that the functions may be implemented on the image processing apparatus 110.

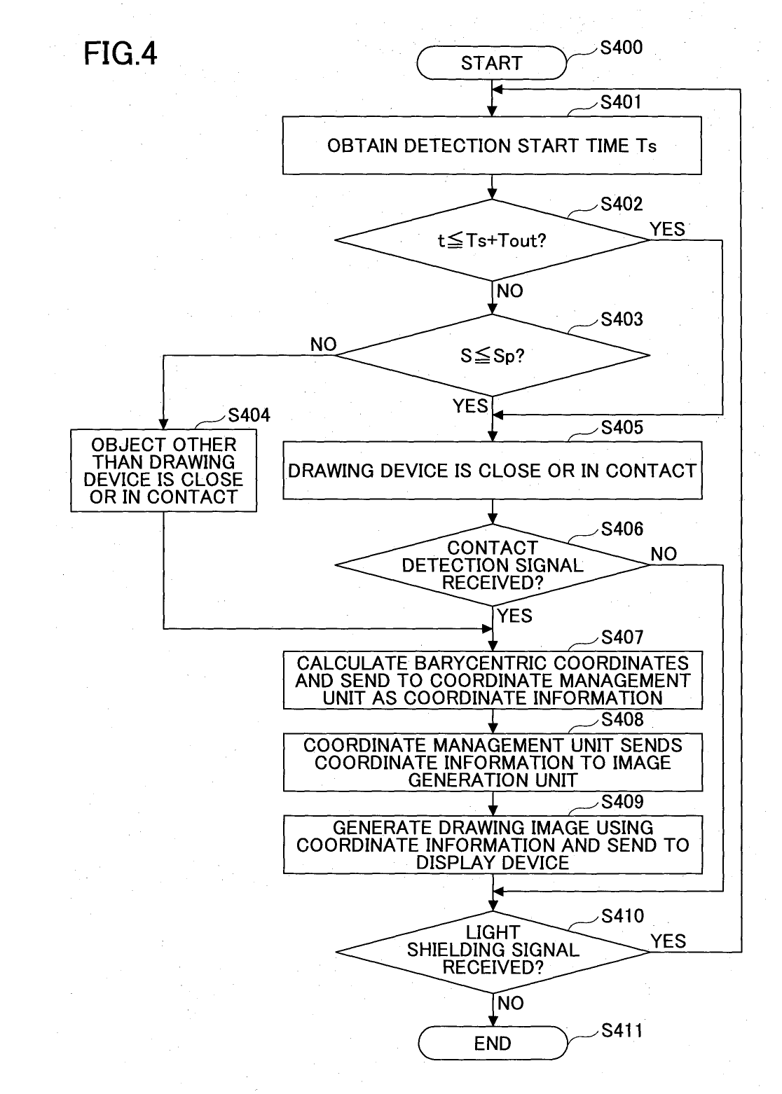

FIG. 4 is a flowchart illustrating process steps executed by the image control apparatus 300 upon receiving a light shielding signal. In the following, a process executed by the image control apparatus 300 is described for identifying an object that is close to or in contact with the display device 112 and generating a drawing image.

The process illustrated in FIG. 4 is started when the image control apparatus 300 receives a light shielding signal from the coordinate detection device 114 in step S400. In step S401, the identification unit 302 of the image control apparatus 300 obtains a detection start time (Ts) corresponding to the time at which the light shielding signal has been received. The image processing apparatus 110 of the present embodiment includes a timer that calculates the current time, and the identification unit 302 may obtain the detection start time (Ts) from the this timer.

In step S402, the identification unit 302 obtains a time (t) at which the present step is being executed and determines whether the time (t) is before a time corresponding to when a predetermined waiting time (Tout) is added to the detection start time (Ts) (t≦Ts+Tout?). The predetermined waiting time (Tout) may be an arbitrary time period such as 50 msec.

If the time (t) is before the time corresponding to when the predetermined waiting time (Tout) is added to the detection start time (Ts) (S402, YES), the process proceeds to step S405. On the other hand, if the time (t) is after the time corresponding to when the predetermined waiting time (Tout) is added to the detection start time (Ts) (S402, NO), the process proceeds to step S403.

In step S403, the identification unit 302 receives light shielding region information from the coordinate detection device 114, uses the received light shielding region information to calculate the area (S) of the light shielding region, and determines whether the area (S) is less than or equal to a threshold value (Sp) (S≦Sp?). The threshold value (Sp) preferably corresponds to the cross-sectional area of the drawing device 120 that shields the light of the coordinate detection device 114 when it comes into contact with the display device 112.

If it is determined in step S403 that the area (S) is greater than the threshold value (Sp) (S403, NO), the process proceeds to step S404. In step S404, the identification unit 302 determines that the light has been shielded by an object other than the drawing device 120, and determines that an object other than the drawing device 120 is close to or is in contact with the display device 112.

On the other hand, if it is determined in step S403 that the area (S) is less than or equal to the threshold value (Sp) (S403, YES), the process proceeds to step S405. In step S405, the identification unit 302 determines that the light has been shielded by the drawing device 120, and determines that the drawing device 120 is close to or in contact with the display device 112.

In step S406, the identification unit 302 determines whether a contact detection signal indicating that the drawing device 120 is in contact with an object is received from the drawing device 120. If the contact detection signal is not received (S406, NO), the process proceeds to step S410. On the other hand, if the contact detection signal is received (S406, YES), the process proceeds to step S407.

In step S407, the identification unit 302 receives light shielding region information from the coordinate detection device 114, uses the received light shielding region information to calculate barycentric coordinates representing the barycenter of the light shielding region, and transmits the calculated barycenter coordinates to the coordinate management unit 304 as coordinate information. In step S408, the coordinate management unit 304 transmits the coordinate information to the image generation unit 306. In step S409, the image generation unit 306 generates a drawing image using the received coordinate information and transmits the generated drawing image to the display device 112.

In step S410, the identification unit 302 determines whether another light shielding signal from the coordinate detection device 114 has been received. If another light shielding signal is received (S410, YES), the process returns to step S401. On the other hand, if no light shielding signal is received (S410, NO), the process is ended in step S411.

In the above-described embodiment, the image control apparatus 300 may determine that the drawing device 120 is close to or in contact with the display device 112 after a predetermined time period has elapsed from the time the light of the coordinate detection device 114 is shielded in a case where the area (S) of the light shielding region is determined to be less than or equal to a predetermined area. That is, in the present embodiment, even after a predetermined time period elapses from the time the drawing device 120 shields the light of the coordinate detection device 114, the image control apparatus 300 does not uniformly determine that an object other than the drawing device 120 is close to or in contact with the display device 112. Accordingly, even in a case where a user shields light of the coordinate detection device 114 using the drawing device 120 but does not draw an image on the display device 112 using the drawing device 120 before the predetermined time elapses from the time the light is shielded, the image control apparatus 300 may still determine that the drawing device 120 is close to or in contact with the display device 112. Also, by generating coordinate information of the contact made by the drawing device 120 upon receiving a contact detection signal and generating a drawing image using this coordinate information, accuracy of the drawing image may be improved, for example.

On the other hand, in a case where a predetermined time elapses from the time light of the coordinate detection device 114 is shielded and the area (S) of the light shielding region is determined to be greater than or equal to a predetermined area, the image control apparatus 300 determines that an object other than the drawing device 120 is close to or in contact with the display device 112. In this case, the image control apparatus 300 calculates the barycenter coordinates of the light shielding region using light shielding region information and generates a drawing image without determining whether a contact detection signal has been received from the drawing device 120.

In the present embodiment, the image control apparatus 300 generates a drawing image even when it determines that an object other than the drawing device 120 is close to or in contact with the display device 112. However, in other embodiments, when it is determined that an object other than the drawing device 120 is close to or in contact with the display device 112, the image control apparatus 300 may transmit a notification to another functional feature of the image processing apparatus 110 indicating the pressing of a UI (user interface) button of the display device 112 displayed at the position corresponding to the coordinate information.

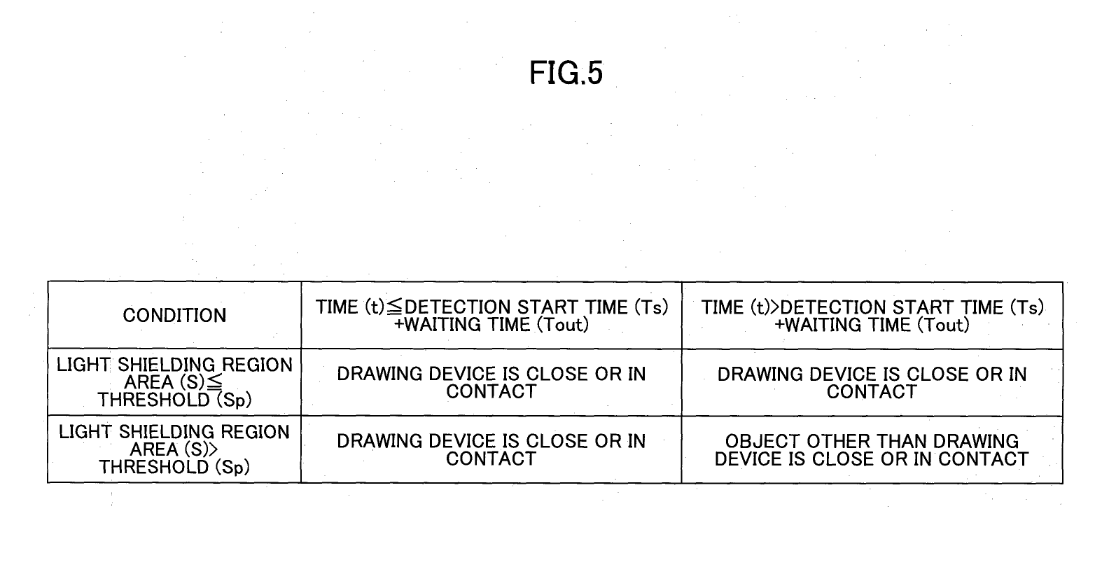

FIG. 5 illustrates a manner of identifying an object that is close to or in contact with the display device 112 of the image processing apparatus 110. As described above with reference to FIG. 4, the identification unit 302 of the image control apparatus 300 determines that the drawing device 120 is close to or in contact with the display device 112 when the time (t) is before the time corresponding to when a predetermined waiting time (Tout) is added to the detection start time (Ts).

In the case where the time (t) is after the time corresponding to when a predetermined waiting time (Tout) is added to the detection start time (Ts), the identification unit 302 identifies the object that is close to or in contact with the display device 112 depending on the relationship between the area (S) of the light shielding region and the threshold value (Sp). That is, if the area (S) is less than or equal to the threshold value (Sp), the identification unit 302 determines that the drawing device 120 is close to or in contact with the display device 112. If the area (S) is greater than the threshold value (Sp), the identification unit 302 determines that an object other than the drawing device 120 is close to or in contact with the display device 112.

While certain preferred embodiments of the present invention have been described above, the present invention is not limited to these embodiments, and numerous variations and modifications may be made without departing from the scope of the present invention.

The present application is based on and claims the benefit of the priority date of Japanese Patent Application No. 2012-098834 filed on Apr. 24, 2012, the entire contents of which are hereby incorporated by reference.

1. An image control apparatus that generates and outputs a drawing image, the image control apparatus comprising:
an identification unit that uses position information of an object that is close to or in contact with a display device, which is controlled to display the drawing image, and determines whether the object corresponds to a drawing device; and
an image generation unit that generates the drawing image using the position information of the object and outputs the generated drawing image;
wherein when the drawing device comes into contact with the display device, the image generation unit generates the drawing image using position information of the drawing device.

2. The image control apparatus as claimed in claim 1, wherein
the position information of the object includes plural coordinates representing a position on a screen of the display device; and
the identification unit determines that the object corresponds to the drawing device when an area of a region represented by the plural coordinates is less than or equal to a predetermined area.

3. The image control apparatus as claimed in claim 1, wherein
the position information of the object is obtained from a detection device that detects a position of the object.

4. The image control apparatus as claimed in claim 1, wherein
the identification unit determines that the drawing device is has come into contact with the display device when a contact detection signal indicating that the drawing device has come into contact with the display device is received from the drawing device.

5. An image processing system, comprising:
an identification unit that uses position information of an object on a display device and determines whether the object corresponds to a drawing device; and
an image generation unit that generates a drawing image using the position information of the object and outputs the generated drawing image;
wherein when the drawing device comes into contact with the display device, the image generation unit generates the drawing image using position information of the drawing device.

6. The image processing system as claimed in claim 5, wherein
the position information of the object includes plural coordinates indicating a position on a screen of the display device; and
the identification unit determines that the object corresponds to the drawing device when an area of a region represented by the plural coordinates is less than or equal to a predetermined area.

7. A computer program product comprising a computer-readable medium having a computer program recorded thereon that is executable by a computer, the computer program, when executed, causing an image control apparatus that generates and outputs a drawing image to perform the steps of:
obtaining position information of an object that is close to or in contact with a display device, which is controlled to display the drawing image;
determining whether the object corresponds to a drawing device using the position information of the object; and
generating the drawing image using position information of the drawing device when the drawing device comes into contact with the display device and outputting the generated drawing image.

8. The computer program product as claimed in claim 7, wherein
the position information of the object includes plural coordinates indicating a position on a screen of the display device; and
when an area of a region represented by the plural coordinates is less than or equal to a predetermined area, the object is determined to correspond to the drawing device.
